(19) United States
(12) Patent Application Publication
(10) Pub. No.: US 2026/0145443 A1
(43) Pub. Date: May 28, 2026

(54) Media Supply with Periodic Media Pattern

(71) Applicant: Zebra Technologies Corporation, Lincolnshire, IL (US)

(72) Inventors: Anthony Ross Helberg, Attleboro, MA (US); David F. Beck, Exeter, RI (US); Victor L. Salmons, Gurnee, IL (US)

(21) Appl. No.: 18/959,956

(22) Filed: Nov. 26, 2024

(51) Int. Cl. B41J 11/46; B41J 15/04; B41J 15/16

(52) U.S. Cl. CPC B41J 11/46; B41J 15/04; B41J 15/16

(57) ABSTRACT

A media supply and a media processing device configured to process the media supply are disclosed. The media supply includes a continuous web having a web length extending along a first axis and a web width extending across a second axis, where the first and second axes are perpendicular to each other. Demarcation features and media units are positioned along the web length. The media units define a repetitive sequential pattern along the web length, where each repetition of the repetitive sequential pattern includes a set of media units. The media units in the set are offset from each other along the web length to form an ordered sequence and at least two of the media units in the set are offset from each other across the web width.

### BACKGROUND

Typically, a media supply of labels to be processed by a label printer includes a continuous web of labels having specified dimensions. As an example, label printers are commonly configured to process media supplies having labels with widths of approximately two or four inches. However, such label printers may also be used to print smaller labels (e.g., such as labels having a width and/or length that is less than two tenths of an inch). These small labels can cause calibration and/or registration issues for label printers. Additionally, media supplies of small labels are conventionally disposed serially and sequentially in a straight line one after another, which can result in uneven or non-uniform wear over time for printer components configured to process larger labels. The uneven or non-uniform wear of printer components can lead to media processing error, print quality degradation, and/or the need to replace the printer components.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example supply of media in accordance with embodiments of the present disclosure.

FIG. 2 illustrates an example composition of an example media supply in accordance with embodiments of the present disclosure.

FIG. 3 illustrates another composition of an example media supply in accordance with embodiments of the present disclosure.

FIG. 4 illustrates another example composition of an example media supply in accordance with embodiments of the present disclosure.

FIG. 5 illustrates an example repetitive and sequential pattern of media units in accordance with embodiments of the present disclosure.

FIG. 6 illustrates another example repetitive and sequential pattern of media units in accordance with embodiments of the present disclosure.

FIG. 7 illustrates another example repetitive and sequential pattern of media units in accordance with embodiments of the present disclosure.

FIG. 8 illustrates another example repetitive and sequential pattern of media units in accordance with embodiments of the present disclosure.

FIG. 9 illustrates another example repetitive and sequential pattern of media units in accordance with embodiments of the present disclosure.

FIG. 10 illustrates another example repetitive and sequential pattern of media units in accordance with embodiments of the present disclosure.

FIG. 11 illustrates another example repetitive and sequential pattern of media units in accordance with embodiments of the present disclosure.

FIG. 12 is a block diagram that illustrates an example media processing device in accordance with embodiments of the present disclosure.

FIG. 13 is a simplified diagram illustrating components of a media processing device interacting with a media supply having a repetitive and sequential pattern of media units in accordance with embodiments of the present disclosure.

FIG. 14 is a flowchart illustrating an example process for processing media via a media processing device in accordance with embodiments of the present disclosure.

FIG. 15 is a flowchart illustrating an example process of forming a media supply having a repetitive and sequential pattern of media units in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of the present disclosure provide for a media supply in which media units have a repetitive, sequential, and periodic media patterns extending along a length and across a width of the media supply. Embodiments of the media supply can include a continuous web having a web length extending along a first axis and a web width extending across a second axis, the first and second axes are perpendicular to each other. Demarcation features and the media units are positioned along the web length. Each of the media units have a media length extending along the first axis and a media width extending along the second axis. The media width of the media units is less than the web width and the media length of the media units is less than the web length. Each repetition of the repetitive and sequential periodic pattern includes a set of media units, where the media units in the set are offset from each other along the web length to form an ordered sequence and at least some of the media units in the set are offset from each other across the web width.

Embodiments of the present disclosure also provide for media processing devices configured to process the embodiments of the media supply. Example media processing devices of the present disclosure can process (e.g., print, encode, etc.) the media units by routing the media units through a media path in a feed direction past various processing components (e.g., printhead, RFID reader/encoder, magnetic stripe reader/encoder etc.).

The media width of the media units can be less than a width of a burn line or a linear array of pixels (also referred to as dots or burn elements) of printhead. The repetitive and sequential periodic patterns of embodiments of the media supplies can facilitate improved calibration and/or registration for smaller labels and/or can facilitate even or uniform wear of printer components over time by distributing a sequence of media units across the width of the media supply and/or the width of the linear array of pixels. The media units of the repetitive and sequential periodic patterns can be offset along a length of the media supply such that the media units can be processed by a media processing device one at a time without requiring the media processing unit to back feed the media units before they are processed.

In accordance with embodiments of the present disclosure, a media supply is disclosed. The media supply includes a continuous web, demarcation features, and media units. The demarcation features have a web length configured to extend along a first axis and a web width configured to extend across a second axis. The first and second axes are perpendicular to each other. The demarcation features are positioned along the web length. Each of the media unit have a media length extending along the first axis and a media width extending along the second axis. The media width of each media unit is less than the web width and the media length of each media unit is less than the web length. The media units define a repetitive and sequential periodic pattern along the web length. Each repetition of the repetitive sequential pattern includes a set of the media units. The media units in the set are offset from each other along the web length to form an ordered sequence and at least two of the media units in the set are offset from each other across the web width. Each repetition of the repetitive and sequential periodic pattern of the plurality of media units along the web length is demarcated by at least one of the demarcation features.

In accordance with embodiments of the present disclosure, a method of forming a media supply is disclosed. The method includes obtaining a continuous web having a web length extending along a first axis and a web width extending across a second axis. The first and second axes are perpendicular to each other. The method also includes defining demarcation features that are positioned along the web length. The method also includes defining media units, where each of the media units have a media length extending along the first axis and a media width extending along the second axis. The media width of each media unit is less than the web width and the media length of each media unit is less than the web length. Defining the media units includes defining a repetitive and sequential periodic pattern of the media units along the web length, where each repetition of the repetitive sequential pattern includes a set of the media units. The media units in the set are offset from each other along the web length to form an ordered sequence and at least two of the media units in the set are offset from each other across the web width. Each repetition of the repetitive and sequential periodic pattern of the media units along the web length is demarcated by at least one of the demarcation features.

In accordance with embodiments of the present disclosure, each repetition of the repetitive and sequential periodic pattern of the media units extends diagonally along the web length and web width.

In accordance with embodiments of the present disclosure a first one of the media units in each repetition of the repetitive and sequential periodic pattern of the media units is disposed proximate to a first side edge of the continuous web and a last one of the plurality of media units in each repetition of the repetitive and sequential periodic pattern of the plurality of media units is disposed proximate to a second side edge of the continuous web. The web width corresponds to a distance between the first and second edges. The first one of the media units can be offset inward from the first edge by a first margin and the last one of the media units can be offset inward of the second edge by a second margin.

In accordance with embodiments of the present disclosure, the media units in the set have an arrangement in which the media units in the set are not aligned with each other along the web length and the web width.

In accordance with embodiments of the present disclosure, at least two of the media units in the set are offset from each other and are partially aligned along one of the web length or the web width. The at least two of the media units in the set are disposed adjacent to each other and the at least two of the media units in the set are offset so that the at least two of the media units overlap in a direction parallel to the second axis by zero percent to twenty-five percent.

In accordance with embodiments of the present disclosure, the set of the media units includes subsets of the media units. The media units in each subset are serially and linearly aligned along the web length and at least two of the subsets are offset relative to each other across the web width.

In accordance with embodiments of the present disclosure, the set of the media units include at least two media units.

In accordance with embodiments of the present disclosure, the media units in the set are at least one of disposed on the continuous web or integral with the continuous web.

In accordance with embodiments of the present disclosure each repetition of the repetitive and sequential periodic pattern of the media units in the set forms one of a diagonal pattern, a zigzag pattern, a stepped diagonal pattern, a V-shaped pattern, or an inverted V-shaped pattern.

In accordance with embodiments of the present disclosure, leading edges of subsequent ones of the media units in the set are offset from leading edges of preceding ones of the media units in the set by at least seventy-five percent of media length.

In accordance with embodiments of the present disclosure, first side edges of subsequent ones of the media units in the set are offset from first side edges of preceding ones of the media units in the set by at least fifty percent of media width.

In accordance with embodiments of the present disclosure, a media processing device is disclosed. The media processing device includes a platen, a printhead, a sensor, and a logic circuit. The printhead is configured to form a nip with the platen. The sensor is disposed proximate to the printhead and is configured to be responsive to demarcation features on a media supply as the media supply is advanced along a feed path in a feed direction past the sensor by the platen. The logic circuit is configured to detect one of the demarcation features based on an output of the sensor and register each of a plurality of media units in a set demarcated by the one of the demarcation features. The media units in the set are offset relative to each other along a length and a width of the media supply and correspond to a repetition of the repetitive and sequential periodic pattern of the plurality of media units. The logic circuit is also configured to control the platen and the printhead to advance the media supply in the feed direction and print on the media units in the set based on a position of the media units in the repetition of the repetitive and sequential periodic pattern.

In accordance with embodiments of the present disclosure, a method processing media units is disclosed. The method includes advancing a media supply along a feed path of a media processing device in a feed direction via control from a logic circuit, detecting a demarcation feature of the media based on an output of a sensor, and registering each media unit in a set of media units demarcated by the demarcation feature. The media units in the set are offset relative to each other along a length and a width of the media supply and correspond to a repetition of a repetitive and sequential periodic pattern of the media units. The method also includes controlling a printhead to print on the media units in the set based on a position of each of the media units in the repetition of the repetitive and sequential periodic pattern.

In accordance with embodiments of the present disclosure, a media width of each media unit in the plurality of media units in the set is less than a width of a linear array of pixels of the printhead. A first subset of pixels of the printhead have a width that correspond to the media width and a first position of a first one of the plurality of media units in the set. A second subset of pixels of the printhead have a width that corresponds to the media width and to a second position of a second one of the plurality of media units in the set. The first and second subset of pixels are offset from each other across the width of the linear array of pixels.

In accordance with embodiments of the present disclosure, the media width, the width of the first subset of pixels, and the width of the second subset of pixels corresponds to between two and twenty percent of the width of the linear array of pixels of the printhead.

In accordance with embodiments of the present disclosure, each of the media units in the set are registered based on a position of each of the media units in the set relative to the demarcation feature.

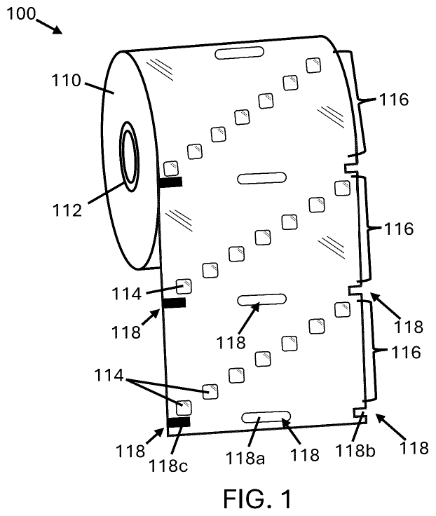

FIG. 1 illustrates an example media supply 100 in accordance with embodiments of the present disclosure. The media supply 100 can include a continuous web 110 that is wound around a core 112 to form a media roll. While the media supply 100 has been illustrated as a media roll, exemplary embodiments of the media supply 100 can have different forms, such as fanfold, sheets or strips, and/or other forms. Media units 114 can be arranged along a width and length of the continuous web 110. The media units 114 can be individual and distinct from each other and can be independently and separately removed from the continuous web 110. The media units 114 can be arranged in media sets 116 that are separated by one or more demarcation features 118. In some examples one or more of the demarcation features 118 can be interspersed with the media units 114 in a set 116. The media units 114 in the sets 116 can be arranged in a repetitive and sequential periodic pattern along a length of the continuous web 110, where each set 116 of media units can correspond to a repetition of the repetitive and sequential periodic pattern.

In one example, the media units 114 can be labels, RF tags/inlays, stamps (e.g., postage stamps or other types of stamps), stickers, a combination thereof, and/or other types of media. The media units 114 can be integrally formed with the continuous web 110 such that when one of the media units 114 is removed from the continuous web 110, a portion of the continuous web 110 is also removed or can be disposed on the continuous web 110 such that when one of the media units 114 is removed from the continuous web 110, the continuous web 110 remains intact. The continuous web 110 and/or the media units 114 can be formed of, for example, one or more of paper, elastomers, polymers, and/or any combination thereof. Polymers used to form the continuous web 110 and/or the media units 114 can include, for example, polyesters, silicones, polyimides, polyurethanes, thermoplastic and/or vinyl polymers, such as polycarbonate, polypropylene, polyethylene, polyethylene terephthalate, nylon, polyvinyl fluoride, and/or Tyvek®, other materials, and/or any combination thereof.

The one or more demarcation features 118 can include, for example, gaps 118a, notches 118b, black marks 118c, other indicia, or a combination thereof, and can be used by a media processing device to calibrate the media processing device to the media supply 100 and/or to register the media units for printing on the media units. While the media supply 100 has been illustrated as including gaps 118a, notches 118b, and black marks 118c, embodiments of the media supply can include one type of demarcation feature (e.g., only gaps 118a, only notches 118b, only black marks 118c) or two types of demarcation features (e.g., two demarcation features from the group consisting of gaps 118a, notches 118b, and black marks 118c). The demarcation features 118 can be disposed periodically along the length of the continuous web 110 between the sets 116 and demarcate the beginning of each repetition of the repetitive and sequential periodic pattern of the media units 114 of the media supply 100.

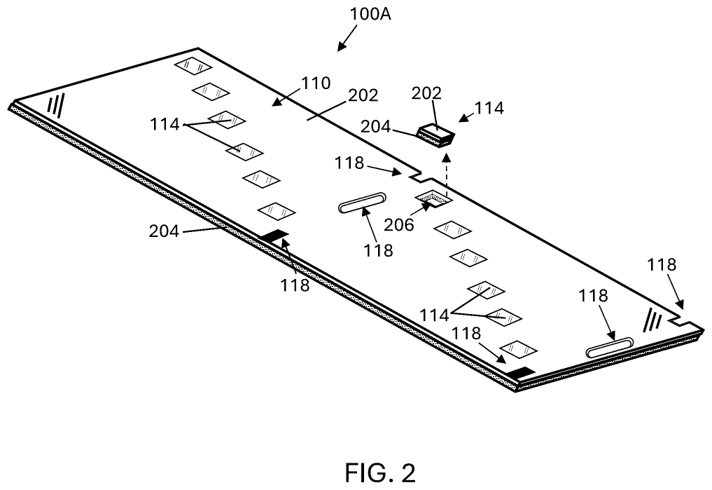

FIGS. 2-4 illustrate compositions of various example media supplies (e.g., embodiments 100A-C) in accordance with embodiments of the present disclosure. With reference to FIG. 2, the media supply 100A can include the continuous web 110. The media units 114 can be formed using the continuous web 110. As one example, the continuous web can be cut and/or perforated to form the media units 114 with the continuous web 110. In one example, at least a portion of the media units 114 can be defined by a percentage cut. The percentage cut can be a cut or score in the continuous web 110 that cuts through a percentage (e.g., 10 to 90 percent) of the continuous web 110 but does not cut completely through the continuous web 110. Using percentage cuts, perforations, or a combination thereof can form lines of weakness between the media units 114 and the remainder of the continuous web 110 that ensures that the media units 114 remain securely attached to the remainder of the continuous web 110 while allowing the media units 114 to be selectively detached/removed from the continuous web 110. When a media unit 114 is detached from the continuous web 110, a hole 206 can be formed in the continuous web 110 at the location where the detached media unit 114 was located. In one example, a first surface 202 of the continuous web 110 and/or the media units 114 can provide a printable surface configured for printing via a media processing device and/or an opposing second surface of the continuous web 110 can include an adhesive layer 204 (e.g., a pressure sensitive adhesive). The illustrated media supply 100A can be, for example, a linerless media supply that is devoid of a (release) liner covering the adhesive layer 204. For embodiments in which the media supply 100A is configured for thermal transfer printing, the first/printable surface 202 of the linerless media is configured to receive a pigment (e.g., ink, resin, wax-resin, etc.) that is transferred from a ribbon supply. For embodiments in which the media supply 100A is configured for direct thermal printing, the first/printable surface can be embedded with or coated with a thermally sensitive dye (e.g., a thermochromic ink) that can be triggered by a thermal printhead of a media processing device that causes the thermally sensitive dye to undergo a chemical and/or physical change (e.g., transparent to colored). Additionally, or alternatively, the media units 114 can include a radiofrequency inlay (RF) inlay (e.g., RFID inlay or NFC inlay) that can be written to and/or read by a RF encoder/reader.

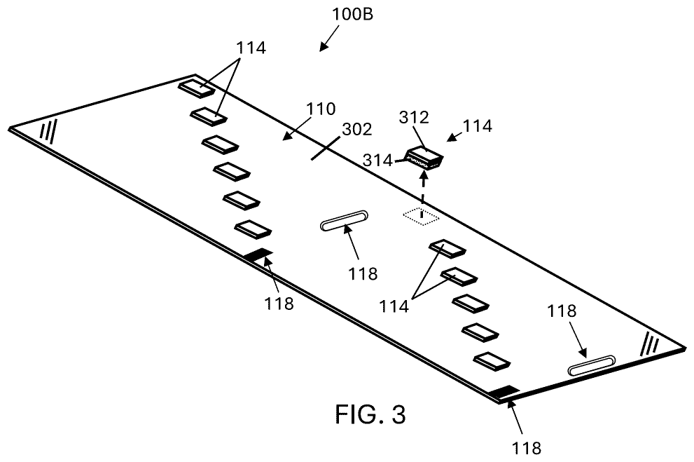

With reference to FIG. 3, the media supply 100B can include the continuous web 110 with the media units 114 disposed on a first surface 302 of the continuous web 110. In one example, first surfaces 312 of the media units 114 can provide a printable surface 312 configured for printing via a media processing device and/or opposing second surfaces of the media units 114 can include an adhesive layer 314 (e.g., a pressure sensitive adhesive). The continuous web 110 of the media supply 100B can be, for example, a release liner that allows the adhesive of the media units 114 to releasably stick to the continuous web 110 and to be selectively detached from the continuous web 110 and adhered to another object. When a media unit 114 is detached from the continuous web 110, the continuous web 110 at the location where the detached media unit was located remains intact. For embodiments in which the media supply 100B is configured for thermal transfer printing, the first/printable surfaces 312 of the media units 114 are configured to receive a pigment (e.g., ink, resin, wax-resin, etc.) that is transferred from a ribbon supply. For embodiments in which the media supply 100B is configured for direct thermal printing, the first/printable surfaces 312 can be embedded with or coated with a thermally sensitive dye (e.g., a thermochromic ink) that can be triggered by a thermal printhead of a media processing device that causes the thermally sensitive dye to undergo a chemical and/or physical change (e.g., transparent to colored). Additionally, or alternatively, the media units 114 can include a radiofrequency inlay (RF) inlay (e.g., RFID inlay or NFC inlay) that can be written to and/or read by a RF encoder/reader.

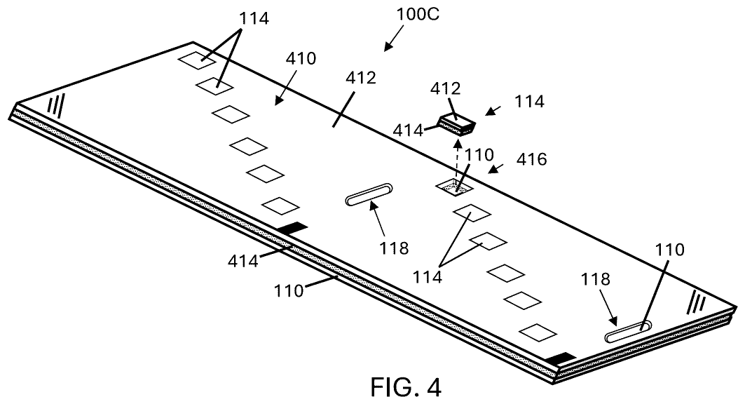

With reference to FIG. 4, the media supply 100C can include the continuous web 110, a media layer 410, and an adhesive layer 414 disposed between the continuous web 110 and the media layer 410. The media units 114 can be formed using the media layer 410. As one example, the media layer 410 can be cut and/or perforated to form the media units 114 with the media layer 410. In one example, the media units 114 can be defined by one or more cuts in the media layer 410 severing the media units 114 from a remainder of the media layer 410. In one example, the media units 114 can be defined by percentage cuts, perforations, or complete cuts through the media layer 410. The media layer 410 surrounding the media units 114 can aid in maintaining a position of the media units 114 on the continuous web 110 and aid in maintaining a position of the media units 114 relative to each other. When a media unit 114 is detached from the continuous web 110, a hole 416 can be formed in the media layer 410 at the location where the detached media unit 114 was located while the continuous web 110 can remain intact. In one example, a first surface 412 of the media layer 410 and/or the media units 114 can provide a printable surface configured for printing via a media processing device and/or an opposing second surface of the media layer 410 can include the adhesive layer 414 (e.g., a pressure sensitive adhesive). The continuous web 110 of the media supply 100C can be, for example, a release liner covering the adhesive. For embodiments in which the media supply 100C is configured for thermal transfer printing, the first/printable surfaces 412 of the media layer 410 and/or media units 114 are configured to receive a pigment (e.g., ink, resin, wax-resin, etc.) that is transferred from a ribbon supply. For embodiments in which the media supply 100C is configured for direct thermal printing, the first/printable surfaces 412 can be embedded with or coated with a thermally sensitive dye (e.g., a thermochromic ink) that can be triggered by a thermal printhead of a media processing device that causes the thermally sensitive dye to undergo a chemical and/or physical change (e.g., transparent to colored). Additionally, or alternatively, the media units 114 can include a radiofrequency inlay (RF) inlay (e.g., RFID inlay or NFC inlay) that can be written to and/or read by a RF encoder/reader.

While FIGS. 2-4 illustrate various examples of media supplies in accordance with embodiments of the present disclosure, exemplary embodiments of the media supplies can include other compositions. Embodiments of media supplies of the present disclosure can include more, fewer, or different layers/materials. As an example, the continuous web 110, the media units 114, and/or the media layer 410 can include a face stock and/or a topcoat.

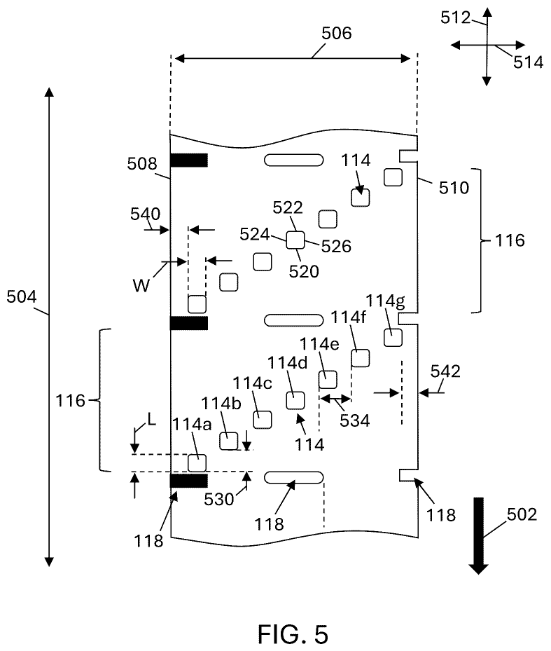

FIG. 5 illustrates an arrangement of media units 114 for an embodiment of the media supply 100 (e.g., embodied as any one of media supplies 100A-C). The media supply 100 can be configured to be processed by a media processing device in a feed direction denoted by arrow 502. A length 504 of the media supply 100 (e.g., a length of the continuous web 110) can be measured in parallel to a first axis 512 that is parallel to the feed direction and a width 506 of the media supply 100 can be measured between edges 508 and 510 of the media supply 100 in parallel to a second axis 514 that is perpendicular to the first axis 512 (and perpendicular to the feed direction 502). In one non-limiting example, the width 506 of the media supply 100 can be between two (2) inches and eight (8) inches (between 50.8 mm and 203.2 mm) or between two (2) inches and four (4) inches (between 50.8 mm and 101.6 mm).

The sets 116 of the media units 114 are arranged along the length 504 of the media supply 100 and demarcated by one or more demarcation features 118. Each of the media units 114 can have a leading edge 520, a trailing edge 522 opposingly spaced from the leading edge 520, and opposing side edges 524 and 526. The media units 114 can each have a media width W measured parallel to the axis 514 (perpendicular to axis 512 and the feed direction) and a media length L measured parallel to the axis 512 (and the feed direction). In one example, the width W of the media units 114 can be between two percent (2%) and seventy-five percent (75%) of the width 506 of the media supply 100 (e.g., the width of the continuous web 110). In one example, the width W of the media units 114 can be between two percent (2%) and twenty percent (20%) of the width 506 of the media supply 100 (e.g., the width of the continuous web 110). In one example, the width W of the media units 114 can be between five percent (5%) and ten percent (10%) of the width 506 of the media supply 100 (e.g., the width of the continuous web 110).

The media units 114 in each set 116 can be arranged along the length 504 and width 506 of the media supply 100 such that the media units 114 are configured to be processed by a media processing device in a sequence where the sequence of the media units 114 in the sets 116 is defined along the length 504 of the media supply 100 (in a direction opposite the feed direction) and determines an order in which the media units 114 are processed by a media processing device. As an example, a first media unit 114A in the ordered sequence of media units 114A-G for one of the sets 116 (where the media unit 114G is the last media unit in the sequence) can be offset relative to one or more of corresponding demarcation features 118 along the length 504 and/or the width 506 and each subsequent media unit 114 in the set 116 (after the first media unit 114A) can be offset along the length 504 (in a direction parallel to the axis 512) from a preceding media unit 114 in the sequence. For example, the (subsequent) media unit 114B can be offset along the length 504 relative to the (preceding) media unit 114A and the (subsequent) media unit 114C can be offset along the length 504 relative to the (previous) media unit 114B. As shown in FIG. 5, for the example sequence of media units 114A-G in the sets 116, each subsequent media unit 114 (after the first media unit 114A) can be offset along the width 506 (in a direction parallel to the axis 514) from the previous media unit 114 in the sequence. As an example, the (subsequent) media unit 114B can be offset along the width 506 relative to the (preceding) media unit 114A and the (subsequent) media unit 114C can be offset relative to the (preceding) media unit 114B. In the present example illustrated in FIG. 5, the offsets of the media units 114 in the sets 116 along the length 504 (in a direction parallel to the axis 512) and width 506 (in a direction parallel to the axis 514) between the first media unit 114A in the sequence and a last media unit 114G in the set 116 creates a diagonally extending pattern of the media units 114 in the sets 116 along the length 504 and across the width 506 of the media supply 100.

In the present example, each subsequent media unit 114 after the first media unit 114A in the set 116 can have an offset 530 measured parallel to the axis 512 between a leading edge 520 of a preceding media unit 114 in the sequence and a leading edge 520 of a subsequent media unit 114 in the sequence. Likewise, each subsequent media unit 114 after the first media unit 114A in the set 116 can have an offset 534 measured parallel to the axis 514 (perpendicular to the axis 512 and the feed direction) from a side edge 524 of a preceding media unit 114 in the sequence to a side edge 524 of a subsequent media unit 114 in the sequence.

The first media unit 114A can be offset inwardly from the edge 508 by a first margin 540 and the last media unit 114G in the sequence can be offset inwardly from the edge 510 by a second margin 542. In one example, the first and second margins 540 and 542 are equal to each other. In one example, the first and second margins 540 and 542 are different from each other. In one example, the margins 540 and 542 are zero.

In one example, the offset 530 can be specified such that there is no overlap or alignment between a preceding media unit 114 and subsequent unit media 114 in a direction parallel to the axis 514 (perpendicular to the axis 512 and the feed direction). For embodiments in which there is no overlap or alignment between a preceding media unit 114 and subsequent unit media 114 in a direction parallel to the axis 514, the offset 530 can be greater than the length L of the media units 114. As an example, the (subsequent) media unit 114B can be offset from the (preceding) media unit 114A in a direction parallel to the axis 512 and opposite the feed direction by a distance that is greater than the length L and the (subsequent) media unit 114C can be offset from the (preceding) media unit 114B in a direction parallel to the axis 512 and opposite the feed direction by a distance that is greater than the length L.

In one example, the offset 530 can be specified such that there is a partial overlap or alignment between a preceding media unit 114 and subsequent unit media 114 in a direction parallel to the axis 514 (perpendicular to the axis 512 and the feed direction). For embodiments in which there is a partial overlap or alignment between a preceding media unit 114 and subsequent media unit 114 in a direction parallel to the axis 514, the offset 530 can be equal to or less than the length L of the media units 114. As an example, the (subsequent) media unit 114B can be offset from the (preceding) media unit 114A in a direction opposite the feed direction by a distance that is equal to or less than the length L and the (subsequent) media unit 114C can be offset from the (preceding) media unit 114B in a direction opposite the feed direction by a distance that is equal to or less than the length L. In one example, less than twenty-five percent (25%) of the subsequent media unit 114 overlaps or aligns with the preceding media unit 114 in a direction parallel to the axis 514. Stated differently, the leading edge 520 of the subsequent media unit 114 (e.g., media unit 114B) is offset from the leading edge 520 of the preceding media unit 114 (e.g., media unit 114B) by a distance that corresponds to at least seventy-five percent (75%) of the length L. In one example, less than twenty percent (20%) of the subsequent media unit 114 overlaps or aligns with the preceding media unit 114 in a direction parallel to the axis 514 (e.g., the leading edge 520 of the subsequent media unit 114, e.g., media unit 114B, is offset from the leading edge 520 of the preceding media unit 114, e.g., media unit 114B, by a distance that corresponds to at least eighty percent, 80%, of the length L). In one example, less than fifteen percent (15%) of the subsequent media unit 114 overlaps or aligns the preceding media unit 114 in a direction parallel to the axis 514 (e.g., the leading edge 520 of the subsequent media unit 114, e.g., media unit 114B, is offset from the leading edge 520 of the preceding media unit 114, e.g., media unit 114B, by a distance that corresponds to at least eighty-five percent, 85%, of the length L). In one example, less than ten percent (10%) of the subsequent media unit 114 overlaps or aligns the preceding media unit 114 in a direction parallel to the axis 514 (e.g., the leading edge 520 of the subsequent media unit 114, e.g., media unit 114B, is offset from the leading edge 520 of the preceding media unit 114, e.g., media unit 114B, by a distance that corresponds to at least ninety percent, 90%, of the length L). In one example, less than five percent (5%) of the subsequent media unit 114 overlaps the preceding media unit 114 in a direction parallel to the axis 514 (e.g., the leading edge 520 of the subsequent media unit 114, e.g., media unit 114B, is offset from the leading edge 520 of the preceding media unit 114, e.g., media unit 114B, by a distance that corresponds to at least ninety-five percent, 90%, of the length L). The amount by which the subsequent media unit 114 overlaps or aligns the preceding media unit 114 in a set 116 can be specified to prevent or mitigate a need to back feed the media supply 100 between processing of the media units 114 by a media processing device. As an example, the amount of overlap or alignment can be specified such that when a media processing device prints on a media unit 114, the media processing device can continue to advance the media supply 100 in the feed direction to print on the subsequent media unit 114 (e.g., as opposed to having to back feed or reverse the direction of travel of the media supply 100 to align or register the subsequent media unit 114 with a printhead of the media processing device before printing on the subsequent media unit 114).

In one example, the offset 534 can be specified such that there is no overlap or alignment between a preceding media unit 114 and subsequent media unit 114 in a direction parallel to the axis 512. For embodiments in which there is no overlap or alignment between a preceding media unit 114 and subsequent media unit 114 in the set 116 in a direction parallel to the axis 512, the offset 534 can be greater than the width W of the media units 114. As an example, the (subsequent) media unit 114B can be offset from the (preceding) media unit 114A in a direction parallel to the axis 514 (perpendicular to the axis 512 and the feed direction) by a distance that is greater than the width W and the (subsequent) media unit 114C can be offset from the (preceding) media unit 114B in a direction parallel to the axis 514 (perpendicular to the axis 512 and the feed direction) by a distance that is greater than the width W.

In one example, the offset 534 can be specified such that a preceding media unit 114 and subsequent media unit 114 at least partially overlap or align in a direction parallel to the axis 512. For embodiments in which there is at least a partial overlap or alignment between a preceding media unit 114 and subsequent media unit 114 in a direction parallel to the axis 512, the offset 534 can be equal to or less than the width W of the media units 114. As an example, the (subsequent) media unit 114B can be offset from the (preceding) media unit 114A in a direction parallel to the axis 514 by a distance that is equal to or less than the width and the (subsequent) media unit 114C can be offset from the (preceding) media unit 114B in a direction parallel to the axis 514 by a distance that is equal to or less than the width W. In one example, a preceding media unit 114 and a subsequent media unit 114 can be aligned in a direction parallel to the axis 512 to completely overlap or align (i.e., 100% overlap or alignment) such that the sides 524 of the preceding and subsequent media units 114 are aligned and the sides 526 of the preceding and subsequent media units 114 are aligned (e.g., the side edge 524 of the subsequent media unit 114, e.g., media unit 114B, is offset from the side edge 520 of the preceding media unit 114, e.g., media unit 114B, by a distance that corresponds to 0% of the width). In one example, the subsequent media unit 114 can overlap or align with the preceding media unit 114 by between zero percent (0%) and fifty percent (50%) (e.g., the side edge 524 of the subsequent media unit 114, e.g., media unit 114B, is offset from the side edge 520 of the preceding media unit 114, e.g., media unit 114B, by a distance that corresponds to 50% to 100% of the width W). The amount by which the subsequent media unit 114 overlaps the preceding media unit 114 in a direction parallel to the axis 512 can be specified based on the widths W of media units 114, the width 506 of the media supply 100 (e.g., of the continuous web 110), a quantity of media units 114 included the sets 116, and/or the first and second margins 540 and 542. As an example, the amount of overlap can be specified such that the media units 114 in the sets 116 traverse the width 506 of the media supply 100 (e.g., between the margins 540 and 542) at least once per set 116.

In one illustrative non-limiting example, the width 506 of the media supply 100 (e.g., a width of the continuous web 110) can be fifty-four millimeters (54 mm). The width W of the media units 114 can be four millimeters (4 mm) and the length L of the media units 114 can be four millimeters (4 mm). The first and second margins 540 and 542 can each be three and four tenths millimeters (3.4 mm). The offset 530 can be four millimeters (4 mm). The offset 534 can be seven and two tenths millimeters (7.2 mm).

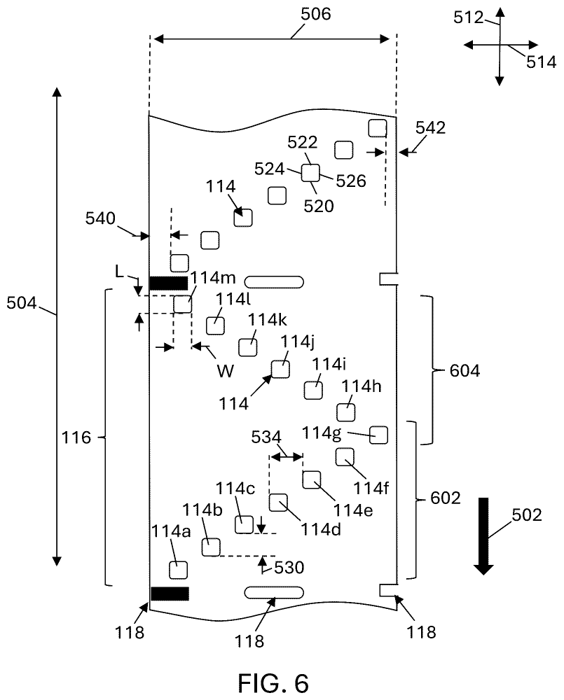

FIG. 6 illustrates another example arrangement of media units 114 for an embodiment of the media supply 100 (e.g., embodied with the composition of any one of media supplies 100A-C) in accordance with embodiments of the present disclosure. The example arrangement in FIG. 6 is similar to the arrangement of media units 114 illustrated in FIG. 5, except that, as shown in FIG. 6, the sets 116 of media units 114 can have a repetitive sequential zigzag pattern. The parameters of the media supply 100 (e.g., length 504 and width 506), the media units 114 (e.g., the widths W and lengths L of the media units), the demarcation feature(s) 118, the axes 512 and 514, the offsets 530 and 534, and/or the margins 540 and 542 described with reference to FIG. 5 are the same for and apply to the example arrangement illustrated in FIG. 6, and therefore, will not be repeated for the sake of brevity. The sets 116 of media units 114 can include a first subset 602 of the media units 114A-G extending diagonally from the side 508 to the side 510 similar to the arrangement shown in FIG. 5 and can include a second subset 604 of media units 114G-M extending diagonally from the side 510 back to the side 508, where the second subset 604 of media units 114 can be positioned subsequent to the first subset 602 in a direction that is parallel to the axis 512 (and the feed direction denoted by the arrow 502). In one example, a last media unit 114G in the first subset 602 can correspond to the first media unit 114G in the second subset 604, as shown in FIG. 6. Alternatively, the first media unit in the second subset 604 can be the media unit 114H.

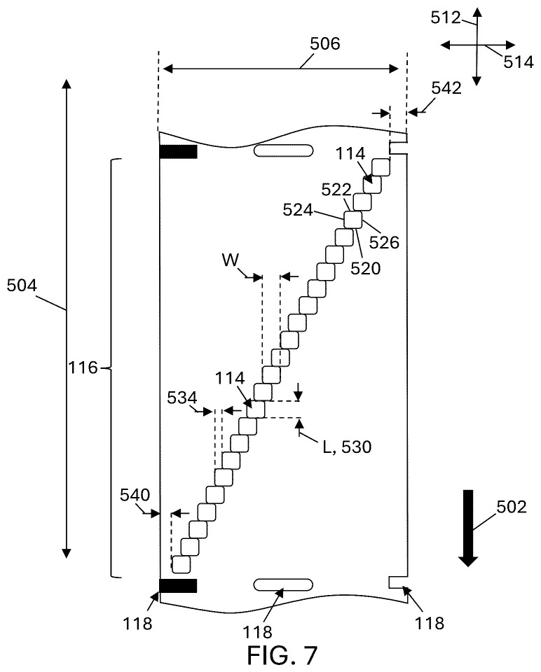

FIG. 7 illustrates another example arrangement of media units 114 for an embodiment of the media supply 100 (e.g., embodied as any one of media supplies 100A-C) in accordance with embodiments of the present disclosure. The example arrangement in FIG. 7 is similar to the arrangement of media units 114 illustrated in FIG. 5, except that, as shown in FIG. 7, the preceding and subsequent media units 114 in the sets 116 partially overlap or align in a direction parallel to the axis 512 to form a diagonal pattern. Preceding and subsequent media units 114 can have an offset 530 in a direction parallel to the axis 512 that is equal to or greater than the length L of the media units 114. Preceding and subsequent media units 114 can have an offset 534 in a direction parallel to the axis 514 that is less than the width W of the media units 114 (e.g., a distance between the side edge 520 of the preceding and subsequent media units is less than the width W and greater than zero). The parameters of the media supply 100 (e.g., length 504 and width 506), the media units 114 (e.g., the widths W and lengths L of the media units), the demarcation feature(s) 118, the axes 512 and 514, the offsets 530 and 534, and/or the margins 540 and 542 described with reference to FIG. 5 are the same for and apply to the example arrangement illustrated in FIG. 7, and therefore, will not be repeated for the sake of brevity.

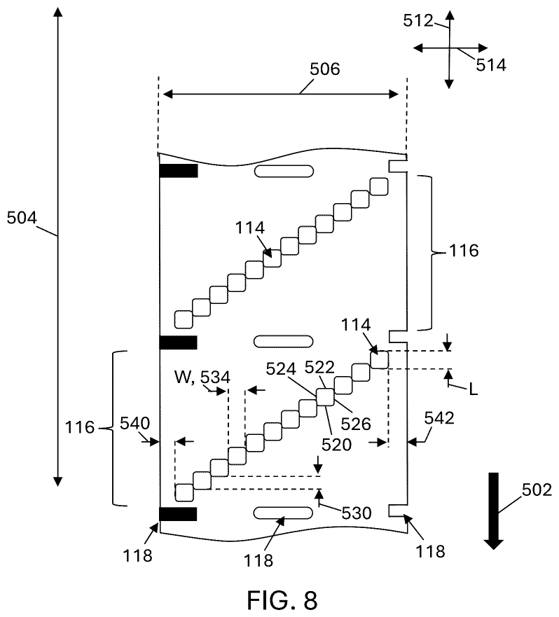

FIG. 8 illustrates an example arrangement of media units 114 for an embodiment of the media supply 100 (e.g., embodied as any one of media supplies 100A-C) in accordance with embodiments of the present disclosure. The example arrangement in FIG. 8 is similar to the arrangement of media units 114 illustrated in FIG. 5, except that, as shown in FIG. 8, the preceding and subsequent media units 114 in the sets 116 partially overlap or align in a direction parallel to the axis 514 to form a diagonal pattern. Preceding and subsequent media units 114 can have an offset 530 that is less than the length L of the media units 114. The offset 534 in a direction parallel to the axis 514 can be equal to or greater than the width W of the media units 114 (e.g., a distance between the leading edge 520 of the preceding and subsequent media units is less than the length L and greater than zero). The parameters of the media supply 100 (e.g., length 504 and width 506), the media units 114 (e.g., the widths W and lengths L of the media units), the demarcation feature(s) 118, axes 512 and 514, the offsets 530 and 534, and/or the margins 540 and 542 described with reference to FIG. 5 are the same for and apply to the example arrangement illustrated in FIG. 8, and therefore, will not be repeated for the sake of brevity.

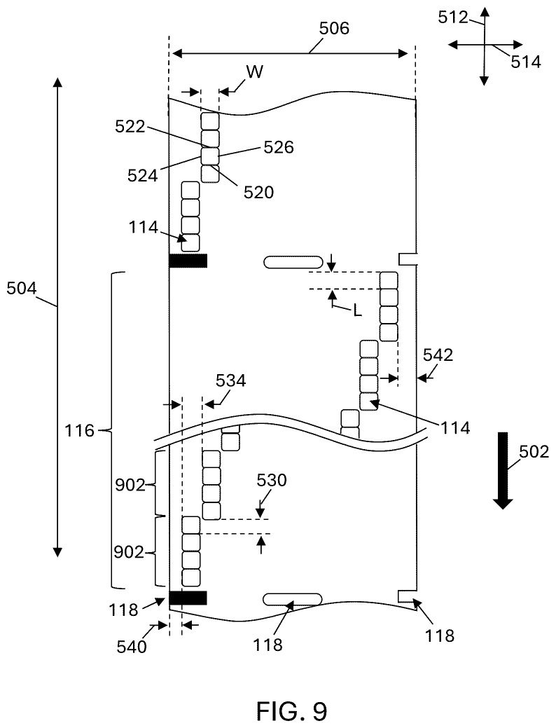

FIG. 9 illustrates another example arrangement of media units 114 for an embodiment of the media supply 100 (e.g., embodied as any one of media supplies 100A-C) in accordance with embodiments of the present disclosure. The example arrangement in FIG. 9 is similar to the arrangement of media units 114 illustrated in FIG. 5, except that, as shown in FIG. 9, the media units 114 in subsets 902 of the sets 116 overlap or align with each other in a direction parallel to the axis 512 such that each subset 902 forms a serial and linear pattern of media units along a length of the media supply in a direction that is parallel to the axis 512. In one example, each of the subsets 902 can include at least two media units 114. Preceding and subsequent subsets 902 of the media units 114 can have an offset 530 in a direction parallel to the axis 512 that is equal to or greater than the length L of the media units 114. The preceding and subsequent subsets 902 of the media units 114 can have an offset 534 in a direction parallel to the axis 514 that is less than, equal to, or greater than the width W of the media units 114. Based on the offsets 530 and 534, the subsets 902 of the media units 114 can extend along the length 504 and width 506 of the media supply 100 in a stepped diagonal pattern, e.g., starting proximate to the side 508 and ending proximate to the side 510. The parameters of the media supply 100 (e.g., length 504 and width 506), the media units 114 (e.g., the widths W and lengths L of the media units), the demarcation feature(s) 118, the axes 512 and 514, the offsets 530 and 534, and/or the margins 540 and 542 described with reference to FIG. 5 are the same for and apply to the example arrangement illustrated in FIG. 9, and therefore, will not be repeated for the sake of brevity.

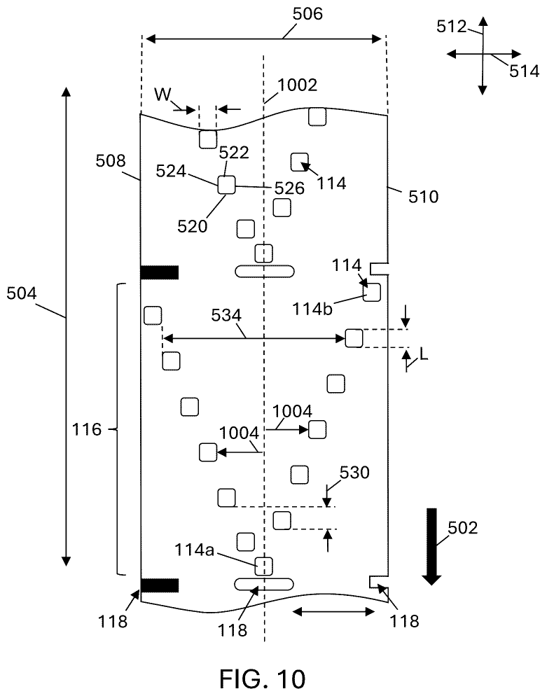

FIG. 10 illustrates another example arrangement of media units 114 for an embodiment of the media supply 100 (e.g., embodied as any one of media supplies 100A-C) in accordance with embodiments of the present disclosure. The example arrangement in FIG. 10 is similar to the arrangement of media units illustrated in FIG. 5, except that, as shown in FIG. 10, the preceding and subsequent media units 114 in the sets 116 form a V-shaped pattern along the length 504 and width 506, where a first media unit 114a in the pattern (the vertex of the V-shaped pattern) is generally centered along a centerline 1002 relative to the width 506 of the media supply 100 (e.g., a width of the continuous web) and subsequent media units 114 alternate between being offset from the centerline 1002 of the media supply towards the side 508 and the side 510 by increasing distances 1004 such that the offset 534 between preceding and subsequent media units 114 increase between the first media unit 114a and the last media unit 114b in a set 116. The parameters of the media supply 100 (e.g., length 504 and width 506), the media units 114 (e.g., the widths W and lengths L of the media units), the demarcation feature(s) 118, the axes 512 and 514, the offsets 530 and 534, and/or the margins 540 and 542 described with reference to FIG. 5 are the same for and apply to the example arrangement illustrated in FIG. 10, and therefore, will not be repeated for the sake of brevity.

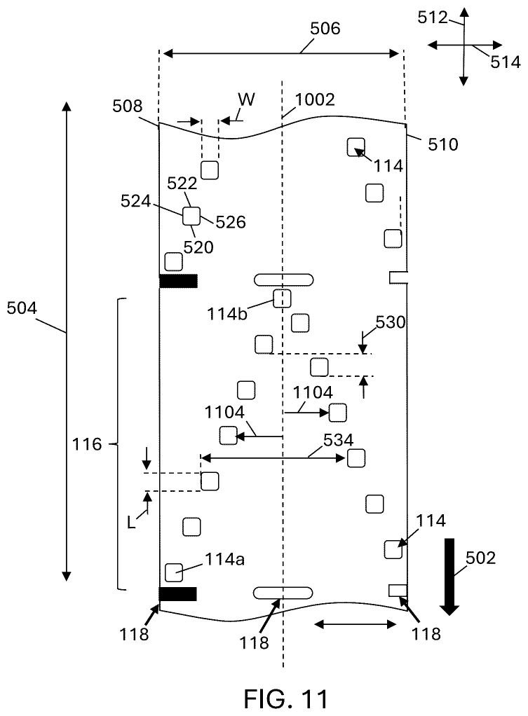

FIG. 11 illustrates another example arrangement of media units 114 for an embodiment of the media supply 100 (e.g., embodied as any one of media supplies 100A-C) in accordance with embodiments of the present disclosure. The example arrangement in FIG. 11 is similar to the arrangement of media units illustrated in FIGS. 5 and 10, except that, as shown in FIG. 11, the preceding and subsequent media units 114 in the sets 116 form an inverted V-shaped pattern along the length 504 and width 506, where a last media unit 114b in the pattern (the vertex of the V-shaped pattern) is generally centered along a centerline 1002 relative to the width 506 of the media supply 100 (e.g., a width of the continuous web) and a first media unit 114 is disposed proximate to a side (e.g., side 508). The first media unit and subsequent media units 114 after the first media unit alternate between being offset from the centerline 1002 of the media supply towards the side 508 and the side 510 by decreasing distances 1004 such that the offsets 534 and 536 between preceding and subsequent media units 114 decrease between the first media unit 114a and the last media unit 114b in a set 116. The parameters of the media supply 100 (e.g., length 504 and width 506), the media units 114 (e.g., the widths W and lengths L of the media units), the demarcation feature(s) 118, the axes 512 and 514, the offsets 530 and 534, and/or the margins 540 and 542 described with reference to FIG. 5 are the same for and apply to the example arrangement illustrated in FIG. 11, and therefore, will not be repeated for the sake of brevity.

While illustrative repetitive and sequential patterns of media units have been illustrated in FIGS. 5-11, embodiments of the media supply 100 can include different repetitive and sequential patterns that distribute a sequence of media units having widths that are less than the width of the media supply (e.g., the continuous web) along the length 504 and across the width 506.

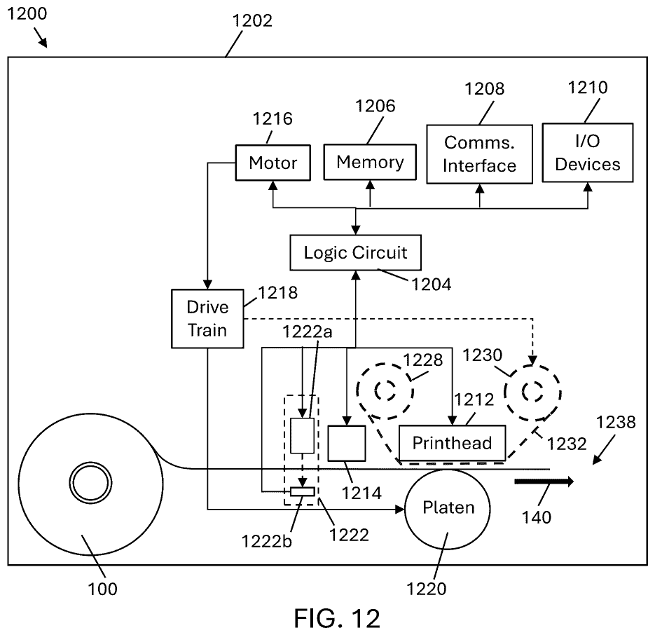

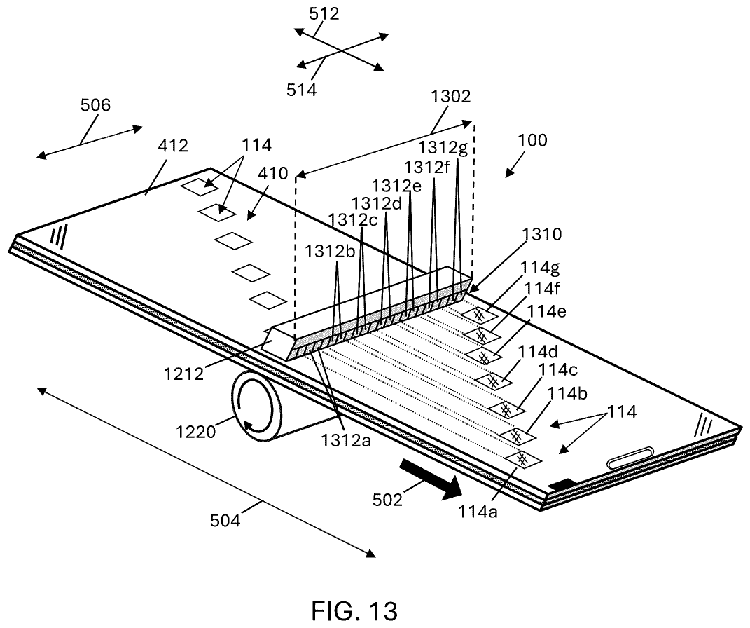

FIG. 12 illustrates a block diagram of an example media processing device 1200, such as a printer, in accordance with embodiments of the present disclosure. FIG. 13 is simplified illustration of an interaction between a printhead and platen of the example media processing device 1200 and an embodiment of the media supply 100. With reference to FIG. 12, the media processing device 1200 can include a housing 1202. The housing 1202 contains or supports one or more components of the media processing device 1200 including, for example, a logic circuit 1204, memory 1206, a communication interface 1208 (e.g., for wired and wireless communication), input/output (I/O) devices 1210 (e.g., a display, switches, buttons, speakers, microphone, etc.), a printhead 1212, a radiofrequency encoder/reader 1214, a motor 1216, a drive train 1218, a platen roller 1220, and a sensor 1222, e.g., formed by an emitter 1222a and a receiver 1222b.

The housing 1202 can be configured to contain an embodiment of the media supply 100 (e.g., having one of the media arrangements described herein with reference to FIGS. 5-11). As an example, the housing 1202 can include a media chamber to store the media supply 100 as it is consumed by the media processing device 1200. The logic circuit 1204 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 1206 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

The logic circuit 1204 of the media processing device 1200 can be operatively coupled to the memory 1206, the communications interface 1208, the I/O devices 1210, the printhead 1212, the radiofrequency encoder/reader 1214, the motor 1216, and/or the sensor 1222. The platen roller 1220 can be driven by the motor 1216 via a drive train 1218 to rotate the platen roller 1220 about an axis of rotation in a first direction (e.g., clockwise in the orientation shown in FIGS. 12 and 13) to pull the continuous web 110 through the feed path in a feed direction denoted by the arrow 502 and output the continuous web 110 and/or the media units 114 from the media processing device via a media exit 1238 formed in the housing 1202 and can be driven by the motor 1216 via the drive train 1218 to rotate the platen roller 1220 about the axis of rotation in a second direction (e.g., counterclockwise in the orientation shown in FIG. 12) to retract or back feed the continuous web 110 and/or the media units 114 (in an opposite direction than the feed direction denoted by the arrow 502). In one example, the logic circuit 1204 can be configured to execute code stored in the memory 1206 to perform operations and functions of the media processing device 1200, e.g., by communicating with and/or controlling one or more of the components of the media processing device 1200. In some embodiments, e.g., for thermal transfer printing, the media processing device 1200 can include a ribbon supply spindle 1228 and a ribbon take up spindle 1230 for supporting an ink ribbon 1232. For direct thermal embodiments, the media processing device 1200 can be devoid of the ribbon supply spindle 1228, the ribbon take-up spindle 1230, and the ink ribbon 1232. The logic circuit 1204 can execute the code stored memory 1206 to implement a printing operation or function that controls the motor 1216 to rotate the platen roller 1220 to feed the media units 114 past the printhead 1212, controls the printhead 1212 to print on the media units 114 (either directly or by transferring an ink from a ribbon to the media), and/or controls the RF encoder/reader 1214 to encode and/or read radiofrequency circuits (e.g., RFID or NFC tags or inlays) included in or on the media units 114. For thermal transfer printing, the printable surfaces of the media units 114 are configured to receive a pigment (e.g., resin, wax-resin, etc.) that is transferred from the ink ribbon 1232 installed on the ribbon supply and take-up spindles 1228 and 1230, respectively, via an operation of the printhead 1212. For direct thermal printing, the printhead 1212 of the media processing device 1200 can selectively heat the printable surface of the media units 114 triggering a chemical or physical change in a thermally sensitive dye covering at least a portion of the printable surface of the media units 114. After sequentially printing on the media units 114, the media units 114 can be further sequentially advanced and output from media processing device 1200 by the operation of the platen roller 1220.

With reference to FIGS. 12 and 13, to ensure the printhead 1212 prints at specified or desired locations on the media units 114 as the media units 114 pass the printhead 1212, the logic circuit 1204 can be configured to calibrate and/or register the media units 114 relative to the printhead 1212, based on an output of the sensor 1222, which is responsive to the demarcation features 118. Detection of the demarcation features 118 of the media supply 100 can be used to locate the designated printing areas of the media units 114. In some instances, the demarcation features 118, from which the designated printing areas can be identified, can include black marks or other indicia, gaps, and/or slits or notches in the media supply 100. As an example, the media supply 100 can include the continuous web 110 of discrete labels (the media units 114), where the web 110 of the labels can include indicia (e.g., black marks), gaps, notches, and slits to that demarcate adjacent a sets of labels of the media supply 100.

Upon detection of one of the demarcation features 118, the logic circuit 1204 of the media processing device 1200 can determine a position of a first media unit (e.g., the media unit 114a) in the repetitive and sequential periodic pattern after the demarcation feature 118 and a position of each of the subsequent media units 114 (e.g., the media units 114b-g) in a repetition of the repetitive and sequential periodic pattern after the first media unit 114 can be determined based on a position of a preceding media unit 114 in the repetitive and sequential periodic pattern. Alternatively, or in addition, upon detection of a demarcation feature 118, a media processing device can determine a position of each of the media units 114 in the repetitive and sequential periodic pattern after the sensed demarcation feature 118 and before the next sensed demarcation feature 118. Using this approach, multiple media units 114 having different positions along the width and length of the media supply 100 (based on the repetitive and sequential periodic pattern) can be calibrated and/or registered based on detection of a demarcation feature 118 by the sensor 1222. By calibrating and/or register multiple media units 114 using detection of a demarcation feature, embodiments of the present disclosure can improve the calibration and registration of the media processing device for smaller media units 114 and/or can improve the speed at which the media processing device can process the media units 114 (e.g., improve the speed at which the media processing device can print on the media units).

With reference to FIGS. 12 and 13, the printhead 1212 and the platen roller 1220 can form a nip. The printhead 1212 have a burn line defined by a linear array of pixels 1310 (also referred to as dots or burn elements). The linear array of pixels can have a width 1302 measured parallel to the axis 514 (perpendicularly to the axis 512 and the feed direction 502) and across the media path. The width 1302 of the linear array of pixels 1310 can define a maximum width of a media unit that can be processed by the media processing device 100. As described herein, the media processing device 1200 can be configured to process a specified width or widths of media supplies, e.g., based on the width 1302 of the linear array of pixels 1310 of the printhead 1212 and/or the dimensions of the platen 1220. As a non-limiting example, an embodiment of the media processing device 1200 can be configured to process a media supply having a width that is equal to or less than two inches (50.8 mm), a media supply having a width that is equal to or less than four inches (101.6 mm), or other media supply widths. As media units of a media supply are conventionally serialized in a linear sequence, when media supplies with media units having the maximum specified width that can be processed by a media processing device, the linear array of pixels of the printhead can print across the width of the media units as needed by a particular print job and the platen can come in contact with the continuous web of the media supply across the width of the platen. However, when a width of media units of a media supply are less than the maximum specified width that can be processed by a media processing device media, for conventional serialized linearly aligned media units there is a first subset of pixels of the printhead that are used to print on the media units and there is a second subset of pixels of the printhead that are not typically used because they do not align with any of the media units. As described herein, over time, the pixels of the printhead in the first subset may fail or degrade while the second subset of pixels may be underutilized and may support printing of additional media units. Additionally, a width of the continuous web of a media supply is conventionally specified to accommodate and correspond to the width of the media units of the media supply (e.g., for a media supply having media units with a width of approximately four inches, the width of the continuous web is approximately four inches and for a media supply having media units with a width of approximately two inches, the width of the continuous web is approximately two inches). When a media supply having a continuous web with a width that is less than the maximum specified width that can be processed by a media processing device, a first portion of the platen may come in contact with the continuous web, while a second portion of the platen may not come in contact with the continuous web or the nip formed between the printhead and the platen may compress the first portion of the platen more than the second portion of the platen, both of which can result in uneven or non-uniform wear of the platen over time. Uneven wear of the platen can affect the print quality of the media processing device and/or can require replacement of the platen.

In an example operation, as shown in FIG. 13, the width W of each media unit 114 is less than the width 1302 of the linear array of pixels 1310 such that a subset of the pixels 1310 are used for each media unit 114. The width of the media supply (the continuous web can be equal to, less than, or greater than the width 1302 of the linear array of pixels 1310. As described herein, the media units 114 of the media supply 100 can have a repetitive and sequential periodic pattern where the media units 114 in the set 116 are offset from each other along the length 504 and at least some of the media units 114 are offset along the width 506. In the present example, the media processing device 1200 has processed media units 114a-g one at a time in the feed direction and has printed indicia on each of the media units 114a-g one at a time. The media units can be offset along the length 506 of the media supply 100 so that the media supply can be continue to be advanced in the feed direction as the printhead prints on each of the media units 114 (e.g., so that the media supply does not need to be back feed in a direction opposite the feed direction before printing on the media units). The media units 114a-g can be aligned with sets 1312a-g of the pixels 1310 across the width of the linear array of pixels 1310 based on a position of the media units 114a-g across the width 506 of the media supply 100 (the width of the continuous web). As an example, the media unit 114a can align with the set 1312a, the media units 114b can align with the set 1312b, the media unit 114c can align with the set 1312c, and so on. When the media units 114 in the set 116 (e.g., 114a-g) do not align or overlap with each other along the length 504 (e.g., the offset 534 is greater than the width of the media units 114), the sets 1312a-g can be mutually exclusive and some of the pixels 1310 in the linear array may not align with any of the media units 114. When the media units 114 in the set 116 (e.g., 114a-g) partially align or overlap with each other along the length 504 (e.g., the offset 534 is greater zero and less than the width of the media units 114), the sets 1312a-g can share one or more pixels 1310. As illustrated in FIG. 13, by utilizing a repetitive and sequential pattern where the media units in the set are offset along the length 504 and width 506, the utilization of the pixels 1310 of the printhead 1212 and the utilization of the platen 1220 can be distributed over their respective width to facilitate even and uniform wear of the printhead 1212 and the platen 1220.

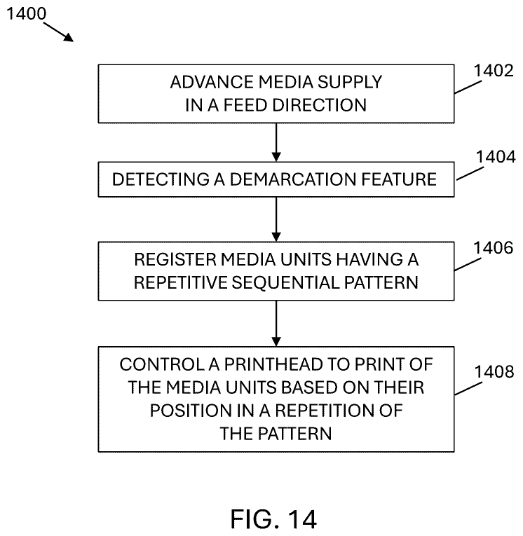

FIG. 14 is a flowchart illustrating an example process 1400 of printing on a media supply (e.g., an embodiment of the media supply 100) in accordance with embodiments of the present disclosure. At operation 1402, the media supply is advanced along a feed path of a media processing device (e.g., media processing device 1200) in a feed direction (e.g., direction 502) via control from a logic circuit (e.g., logic circuit 1204). At operation 1404, a demarcation feature (demarcation feature 118) of the media supply is detected (by the logic circuit) based on an output of a sensor (e.g., sensor 1222). At operation 1406, each of media units (e.g., media units 114) in a set (e.g., set 116) of media units demarcated by the demarcation feature are registered. The media units in the set are offset (e.g., offsets 530 and 534) relative to each other along a length (e.g., length 504) and a width (e.g., width 506) of the media supply and correspond to a repetition of the repetitive sequential pattern of the media units. At operation 1408, a printhead (e.g., printhead 1212) is controlled (by the logic circuit) to print on the media units in the set based on a position of the media units in the repetition of the repetitive sequential pattern.

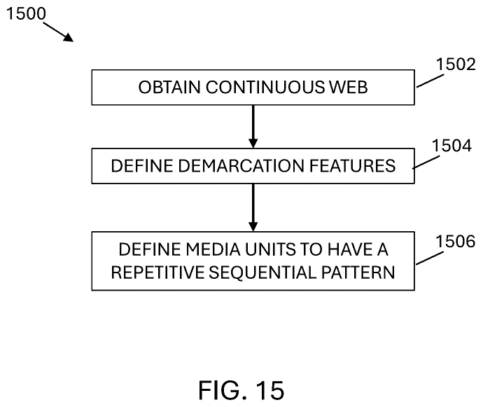

FIG. 15 is a flowchart illustrating an example process 1500 of forming a media supply (e.g., an embodiment of the media supply 100) in accordance with embodiments of the present disclosure. At operation 1502, a continuous web (e.g., continuous web 110) is obtained. The continuous web has a web length (e.g., length 504) extending along a first axis (e.g., axis 512) and a web width (e.g., width 506) extending across a second axis (e.g., axis 514). The first and second axes are perpendicular to each other. At operation 1504, demarcation features (e.g., demarcation features 118) are defined. The demarcation features are positioned along the web length. At operation 1506, media units (e.g., media units 114) are defined. Each of the media units having a media length extending along the first axis and a media width extending along the second axis. The media width of the media units is less than the web width and the media length of the media units is less than the web length. The media units can define a repetitive sequential pattern along the web length, where each repetition of the repetitive sequential pattern includes a set (e.g., set 116) of media units. The media units in the set are offset (e.g., offset 530) from each other along the web length to form an ordered sequence and at least two of the media units in the set are offset (e.g., offset 534) from each other across the web width. Each repetition of the repetitive sequential pattern of the media units along the web length is demarcated by at least one of the demarcation features.

The above description refers to diagrams of the accompanying drawings. Alternative implementations of the example represented by the diagrams include one or more additional or alternative elements, processes, and/or devices. Additionally, or alternatively, one or more of the example elements of the diagram may be combined, divided, re-arranged, or omitted.

The above description refers to a block diagram of the accompanying drawings. Alternative implementations of the example represented by the block diagram includes one or more additional or alternative elements, processes, and/or devices. Additionally, or alternatively, one or more of the example blocks of the diagram may be combined, divided, re-arranged, or omitted. Components represented by the blocks of the diagram are implemented by hardware, software, firmware, and/or any combination of hardware, software, and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged, or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A media supply, comprising:
a continuous web having a web length configured to extend along a first axis and a web width configured to extend across a second axis, the first and second axes are perpendicular to each other;
a plurality of demarcation features positioned along the web length; and
a plurality of media units, each media unit in the plurality of media units having a media length extending along the first axis and a media width extending along the second axis, the media width of each media unit in the plurality of media units is less than the web width and the media length of each media unit in the plurality of media units is less than the web length,
the plurality of media units define a repetitive and sequential periodic pattern along the web length, each repetition of the repetitive sequential pattern includes a set of the plurality of media units, the plurality of media units in the set are offset from each other along the web length to form an ordered sequence and at least two of the plurality of media units in the set are offset from each other across the web width, and
each repetition of the repetitive and sequential periodic pattern of the plurality of media units along the web length is demarcated by at least one of the plurality of demarcation features.

2. The media supply of claim 1, wherein each repetition of the repetitive and sequential periodic pattern of the plurality of media units extends diagonally along the web length and web width.

3. The media supply of claim 1, wherein a first one of the plurality of media units in each repetition of the repetitive and sequential periodic pattern of the plurality of media units is disposed proximate to a first side edge of the continuous web and a last one of the plurality of media units in each repetition of the repetitive and sequential periodic pattern of the plurality of media units is disposed proximate to a second side edge of the continuous web, the web width corresponding to a distance between the first and second edges.

4. The media supply of claim 3, wherein the first one of the plurality of media units is offset inward from the first edge by a first margin and the last one of the plurality of media units is offset inward of the second edge by a second margin.

5. The media supply of claim 1, wherein the plurality of media units in the set have an arrangement in which the plurality of media units in the set are not aligned with each other along the web length and the web width.

6. The media supply of claim 1, wherein at least two of the plurality of media units in the set are offset from each other and are partially aligned along one of the web length or the web width.

7. The media supply of claim 6, wherein the at least two of the plurality of media units in the set are disposed adjacent to each other and the at least two of the plurality of media units in the set are offset so that the at least two of the plurality of media units overlap in a direction parallel to the second axis by zero percent to twenty-five percent.

8. The media supply of claim 1, wherein the set of the plurality of media units includes subsets of the plurality of media units, the plurality of media units in each subset are serially and linearly aligned along the web length and at least two of the subsets are offset relative to each other across the web width.

9. The media supply of claim 1, wherein the set of the plurality of media units include at least two media units.

10. The media supply of claim 1, wherein the plurality of media units in the set are at least one of disposed on the continuous web or integral with the continuous web.

11. The media supply of claim 1, wherein each repetition of the repetitive and sequential periodic pattern of the plurality of media units in the set forms one of a diagonal pattern, a zigzag pattern, a stepped diagonal pattern, a V-shaped pattern, or an inverted V-shaped pattern.

12. The media supply of claim 1, wherein leading edges of subsequent ones of the plurality of media units in the set are offset from leading edges of preceding ones of the plurality of media units in the set by at least seventy-five percent of media length.

13. The media supply of claim 1, wherein first side edges of subsequent ones of the plurality of media units in the set are offset from first side edges of preceding ones of the plurality of media units in the set by at least fifty percent of media width.

14. A method comprising:
obtaining a continuous web, the continuous web having a web length extending along a first axis and a web width extending across a second axis, the first and second axes are perpendicular to each other;
defining a plurality of demarcation features, the plurality of demarcation features being positioned along the web length; and
defining a plurality of media units, each media unit in the plurality of media units having a media length extending along the first axis and a media width extending along the second axis, the media width of each media unit in the plurality of media units is less than the web width and the media length of each media unit in the plurality of media units is less than the web length,
wherein defining the plurality of media units includes defining a repetitive and sequential periodic pattern of the plurality of the media units along the web length, each repetition of the repetitive sequential pattern includes a set of the plurality of media units, the plurality of media units in the set are offset from each other along the web length to form an ordered sequence and at least two of the plurality of media units in the set are offset from each other across the web width, each repetition of the repetitive and sequential periodic pattern of the media units along the web length is demarcated by at least one of the plurality of demarcation features.

15. The method of claim 14, wherein defining the plurality of media units further comprises:
disposing a first one of the plurality of media units in each repetition of the repetitive and sequential periodic pattern of the plurality of media units proximate to a first side edge of the continuous web; and
disposing a last one of the plurality of media units in each repetition of the repetitive sequential periodic pattern of the plurality of media units proximate to a second side edge of the continuous web, the web width corresponding to a distance between the first and second edges.

16. The method of claim 14, wherein defining the media units further comprises:
offsetting at least two of the plurality of media units in the set from each other so that the at least two of the plurality of media units in the set are partially aligned along one of the web length or the web width.

17. The method of claim 14, wherein defining the media units further comprises:
defining subsets in the set of the plurality of media units;
aligning the plurality of media units in each subset serially and linearly along the web length; and
offsetting at least two of the subsets relative to each other across the web width.

18. The method of claim 14, wherein each repetition of the repetitive and sequential periodic pattern forms one of a diagonal pattern, a zigzag pattern, a stepped diagonal pattern, a V-shaped pattern, or an inverted V-shaped pattern.

19. A media processing device, comprising:
a platen;
a printhead configured to form a nip with the platen;
a sensor disposed proximate to the printhead, the sensor configured to be responsive to demarcation features on a media supply as the media supply is advanced along a feed path in a feed direction past the sensor by the platen; and
a logic circuit, the logic circuit configured to:
detect one of the demarcation features based on an output of the sensor;
register each of a plurality of media units in a set demarcated by the one of the demarcation features, the plurality of media units in the set are offset relative to each other along a length and a width of the media supply and correspond to a repetition of the repetitive and sequential periodic pattern of the plurality of media units; and
control the platen and the printhead to advance the media supply in the feed direction and print on the plurality of media units in the set based on a position of the plurality of media units in the repetition of the repetitive and sequential periodic pattern.

20. The media processing device of claim 19, wherein a media width of each media unit in the plurality of media units in the set is less than a width of a linear array of pixels of the printhead,
a first subset of pixels of the printhead have a width that correspond to the media width and a first position of a first one of the plurality of media units in the set, and
a second subset of pixels of the printhead have a width that corresponds to the media width and to a second position of a second one of the plurality of media units in the set where the first and second subset of pixels are offset from each other across the width of the linear array of pixels.

21. The media processing device of claim 20, wherein the media width, the width of the first subset of pixels, and the width of the second subset of pixels corresponds to between two and twenty percent of the width of the linear array of pixels of the printhead.

22. The media processing device of claim 19, wherein each of the plurality of media units in the set are registered based on a position of each of the plurality of media units in the set relative to the demarcation feature.

23. A method comprising:
advancing a media supply along a feed path of a media processing device in a feed direction via control from a logic circuit;
detecting a demarcation feature of the media based on an output of a sensor;
registering each of a plurality of media units in a set of media units demarcated by the demarcation feature, the plurality of media units in the set are offset relative to each other along a length and a width of the media supply and correspond to a repetition of a repetitive and sequential periodic pattern of the plurality of media units; and
controlling a printhead to print on the plurality of media units in the set based on a position of each of the plurality of media units in the repetition of the repetitive and sequential periodic pattern.
